(19) United States
(12) Patent Application Publication
(10) Pub. No.: US 2011/0074210 A1
(43) Pub. Date: Mar. 31, 2011

(54) Noiseless Elastomeric Tracks For Tracked Vehicles

(76) Inventors: Michel Paradis, Granby (CA); Stephane Pilette, Canton-De-Hatley (CA); Jules Dandurand, Sherbrooke (CA)

(21) Appl. No.: 12/891,350

(22) Filed: Sep. 27, 2010

Related U.S. Application Data
(63) Continuation-in-part of application No. 11/857,955, filed on Sep. 19, 2007, now Pat. No. 7,806,487.
(60) Provisional application No. 60/826,551, filed on Sep. 22, 2006.

(51) Int. Cl. B62D 55/096; B62D 55/24

(52) U.S. Cl. 305/165

(57) ABSTRACT

An endless track for providing traction to a snowmobile is provided. The endless track comprises an elastomeric body comprising an inner side for facing a plurality of wheels of the snowmobile and a ground-engaging outer side for engaging the ground. The endless track also comprises a plurality of elastomeric traction projections on the ground-engaging outer side. The endless track is free of transversal reinforcing rods extending transversally to a longitudinal direction of the endless track. When the snowmobile is operated at a given speed, less noise is generated than if the endless track had transversal reinforcing rods embedded in the elastomeric body where respective ones of the elastomeric traction projections are located but was otherwise identical.

### CROSS-REFERENCE TO RELATED APPLICATIONS

This application is a continuation-in-part and claims the benefit under 35 USC 120 of U.S. patent application Ser. No. 11/857,955 filed on Sep. 19, 2007, which claims the benefit under 35 USC 119(e) of U.S. Provisional Patent Application No. 60/826,551 filed on Sep. 22, 2006. Both of these earlier applications are hereby incorporated by reference herein.

### FIELD OF THE INVENTION

The present invention relates to tracked vehicles and, more specifically, to noiseless elastomeric tracks for tracked vehicles.

### BACKGROUND OF THE INVENTION

A track for a tracked vehicle typically comprises an endless drive belt trained around drive sprockets or wheels for driving the belt in an endless path.

As illustrated in FIG. 1 (prior art), the belt 12 has an inner surface 14 and a ground-engaging outer surface 16, which, as it passes along a lower run of the belt 12, engages a ground surface (not shown) to be traversed.

The ground-engaging outer surface 16 comprises a series of projecting and transversally extending traction lugs 20. The traction lugs 20 are regularly spaced apart in a longitudinal direction of the track at a pitch P.

Typically, the endless belt 12 is made of flexible rubber or other elastomeric material and reinforcing rods 24 are embedded in the elastomeric material of the body of the belt 12, at the same pitch spacing P, each of which extends transversally substantially over the entire width of the track. The thickness of the track is locally increased in the region of the embedded reinforcing rods, corresponding to the region of the traction lugs 20. Such reinforcing rods 24 provide transverse rigidity to the track.

The inner track surface 14 is typically provided with a series of drive lugs 18, which are spaced along the length of the inside surface of the belt 12 at the same pitch P, for engaging drive wheels (not shown) as is well known in the art.

Ongoing efforts are made in the field of tracked vehicles to try and reduce the overall noise level of this type of vehicles. The regularity of the pitch spacing of the various elements discussed hereinabove has been recognized as contributing to the overall noise level of tracked vehicles.

Therefore, it has been contemplated achieving noise reduction through non-uniform spacing of the lugs forming the tread of the ground-engaging surface. It has also been suggested to ensure that the spacing of the external ground engaging lugs is at a different pitch from the spacing of the internal drive lugs (see for example U.S. Pat. No. 5,709,440, incorporated by reference herein).

There is still a need in the art for noiseless elastomeric tracks.

### SUMMARY OF THE INVENTION

According to one broad aspect, the present invention provides an endless track for providing traction to a snowmobile. The endless track comprises an elastomeric body comprising an inner side for facing a plurality of wheels of the snowmobile and a ground-engaging outer side for engaging the ground. The plurality of wheels comprises a drive wheel to impart motion to the endless track. The elastomeric body has a thickness. The endless track also comprises a plurality of elastomeric traction projections on the ground-engaging outer side. Each elastomeric traction projection of the plurality of elastomeric traction projections has a height greater than the thickness of the elastomeric body. The endless track is free of transversal reinforcing rods extending transversally to a longitudinal direction of the endless track.

According to another broad aspect, the present invention provides an endless track for providing traction to a snowmobile. The endless track comprises an elastomeric body comprising an inner side for facing a plurality of wheels of the snowmobile and a ground-engaging outer side for engaging the ground. The plurality of wheels comprises a drive wheel to impart motion to the endless track. The endless track also comprises a plurality of elastomeric traction projections on the ground-engaging outer side. The endless track is free of transversal reinforcing rods extending transversally to a longitudinal direction of the endless track. When the snowmobile is operated at a given speed, less noise is generated than if the endless track had transversal reinforcing rods embedded in the elastomeric body where respective ones of the elastomeric traction projections are located but was otherwise identical.

According to another broad aspect, the present invention provides an endless track for providing traction to a snowmobile. The endless track comprises an elastomeric body comprising an inner side for facing a plurality of wheels of the snowmobile and a ground-engaging outer side for engaging the ground. The plurality of wheels comprises a drive wheel to impart motion to the endless track. The endless track also comprises a plurality of elastomeric traction projections on the ground-engaging outer side. The endless track is free of transversal reinforcing rods extending transversally to a longitudinal direction of the endless track. The endless track contains a plurality of different elastomers which have different rigidities.

According to another broad aspect, the present invention provides an endless track for providing traction to a snowmobile. The endless track comprises an elastomeric body comprising an inner side for facing a plurality of wheels of the snowmobile and a ground-engaging outer side for engaging the ground. The plurality of wheels comprises a drive wheel to impart motion to the endless track. The endless track also comprises a plurality of elastomeric traction projections on the ground-engaging outer side. The endless track is free of transversal reinforcing rods extending transversally to a longitudinal direction of the endless track. Elastomeric material of the endless track has an average modulus of elasticity of at least 5.4 MPa.

Other objects, advantages and features of the present invention will become more apparent upon reading of the following non-restrictive description of embodiments of the invention, given by way of example only, with reference to the accompanying drawings.

### BRIEF DESCRIPTION OF THE DRAWINGS

In the appended drawings:

FIG. 1 is a longitudinal sectional view of a portion of a track as known in the art;

FIGS. 2A and 2B are longitudinal sectional views of a portion of a track according to embodiments of the present invention, a) with a reinforcing rod at every two traction lugs; and b) with no reinforcing rod;

FIG. 3 is a graph of results of tests, of sound levels (in dB) versus frequency (in Hz), conducted on a track of the prior art (diamonds); on a first track according to an embodiment of the present invention (squares), and on a second track according to an embodiment of the present invention (triangles);

FIG. 4 is a graph of results of tests, of sound levels (in dB) versus speed (in mi/hr), conducted on a track of the prior art (squares); on a first track according to an embodiment of the present invention (diamonds), and on a second track according to an embodiment of the present invention (triangles);

FIG. 5 is a graph of results of tests, of power (in hp) versus speed (in mi/hr), conducted on a track of the prior art (squares); on a first track according to an embodiment of the present invention (diamonds), and on a second track according to an embodiment of the present invention (triangles);

FIG. 6 is a top view of a portion of an endless track in accordance with another embodiment of the present invention, the endless track being free of reinforcing rods;

FIGS. 7 and 8 are transversal sectional views of the endless track of FIG. 6;

FIGS. 9 and 10 are longitudinal sectional views of the endless track of FIG. 6;

FIGS. 11 to 13 show results of sound tests conducted on the endless track of FIG. 6 and a comparative reference endless track which is identical to the endless track except that it comprises reinforcing rods;

FIG. 14 shows an example of a snowmobile to which the endless track of FIG. 6 provides traction; and

FIGS. 15 and 16 are longitudinal sectional views of the comparative reference endless track.

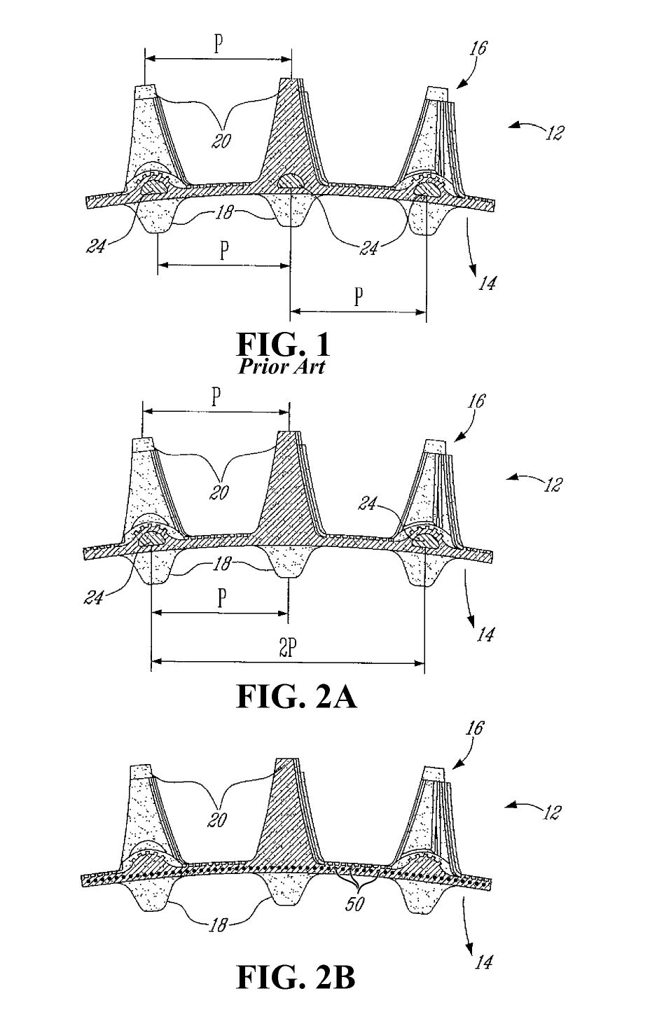

### DESCRIPTION OF EMBODIMENTS

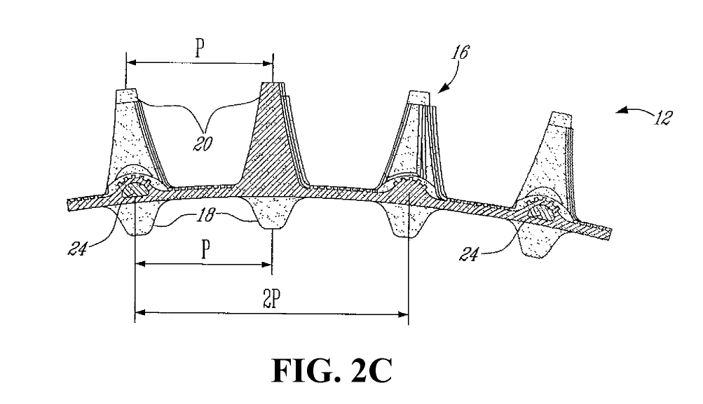

Turning to FIG. 2A of the appended drawings, a track 12 according to an embodiment of the present invention will now be described.

Reinforcing rods 24 are embedded in the rubber material of the body of the belt 12, at a pitch spacing 2P multiple of the pitch spacing P of the traction lugs 20, each of which extends transversally over substantially the entire width of the track on the ground-engaging surface 16. The reinforcing rods may be fiberglass reinforced, as known in the art.

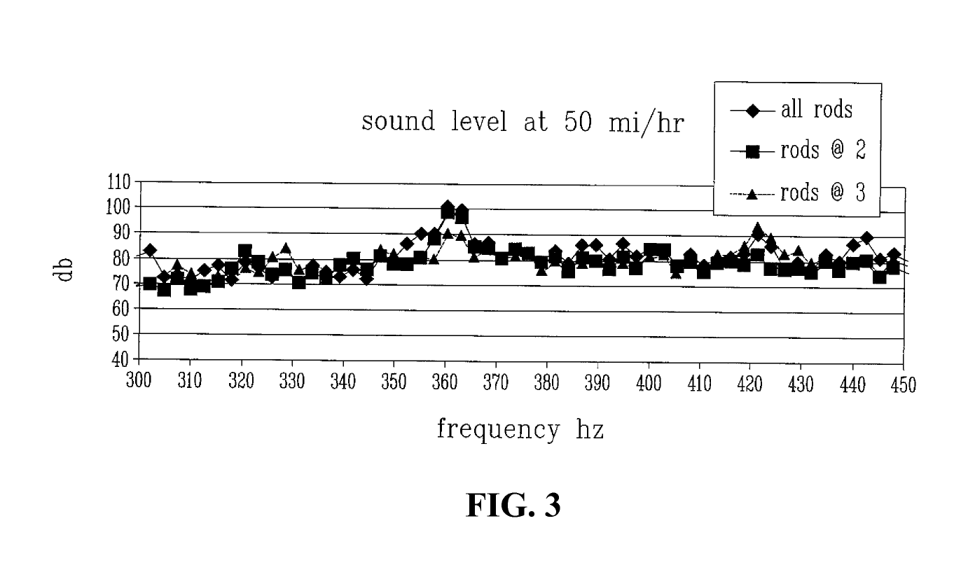

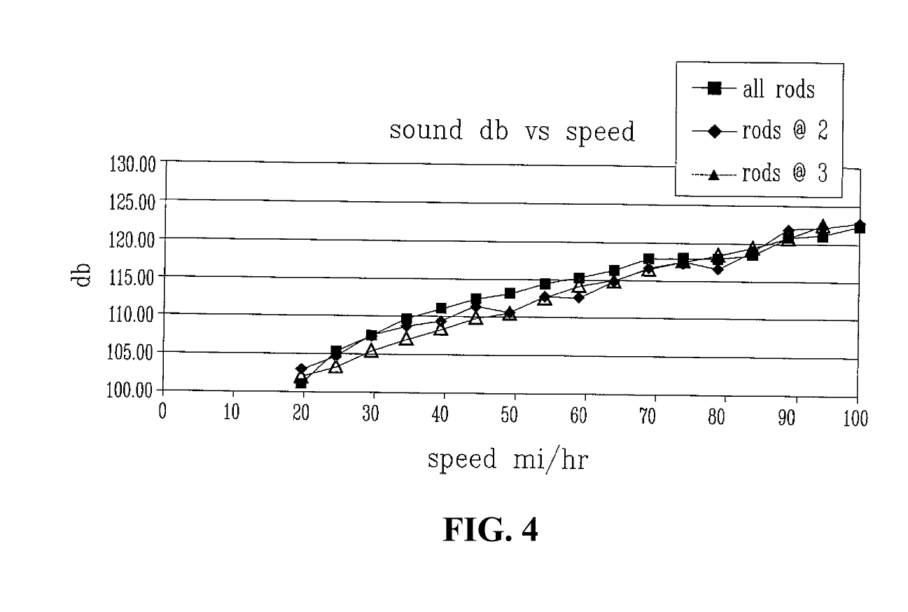

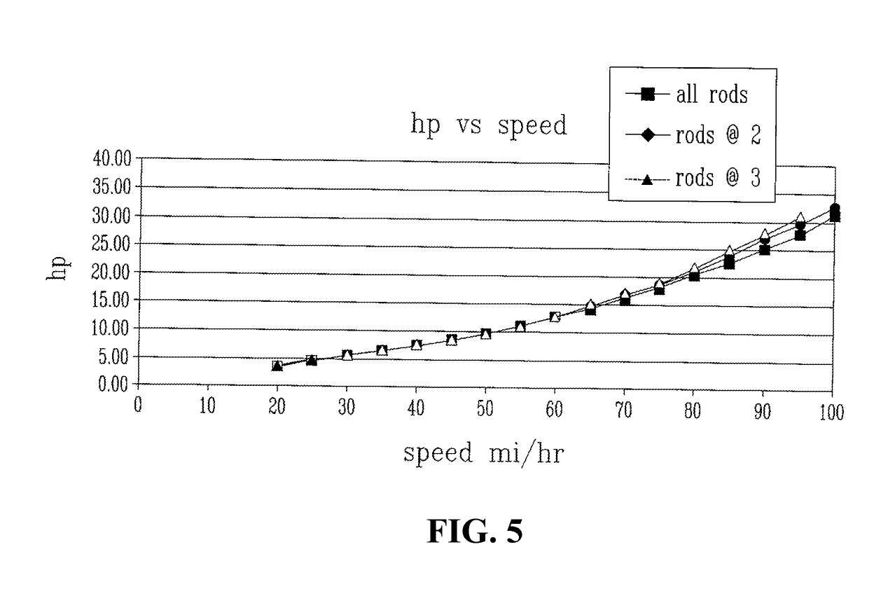

FIG. 3 shows the spectral analysis of the amplitude (in decibels) of the noise produced by a tracked vehicle operating at a speed of about 50 ml/hr, at different frequencies from 300 to 450 Hz. As may be seen, at 360 Hz, the noise generated when using a track as of the prior art, i.e. with reinforcing rods at every traction lug (diamonds in FIG. 3 and squares in FIGS. 4 and 5), is of 101 dB, versus 99 dB (−2) when using a track according to an embodiment of the present invention with reinforcing rods only at every two traction lugs (squares in FIG. 3 and diamonds in FIGS. 4 and 5), and 90 dB (−11) when using a track according to an embodiment of the present invention with reinforcing rods only at every three traction lugs (triangles in FIGS. 3-5).

Moreover, resistance tests show that, contrary to a general thinking in the field, the rubber body, which, by construction, is flexible in its longitudinal direction, is sufficiently stiffened in the transverse direction by such reinforcing rods only present at every two (2) or three (3) traction lugs 20 for example.

The present tracks allow reducing the level of generated noise. Moreover, since the number of reinforcement rods is reduced, the tracks are lighter in weight (for example by 1.45 kg based on a prior art track of 15.8 kg, based on a 15″ large×121″ long track for example). People in the art will further appreciate that the production time of such tracks is shortened by up to 10%, which further contributes to the decrease of costs.

As can be seen from FIGS. 4 and 5, the reduction in noise is achieved by using tracks of the present invention in tracked vehicles of about 17 hp at a speed of about 70 ml/hr. At upper speeds, it is found that the tracks with a reduced number of reinforcing rods are subject to increased vibration.

A track with no reinforcing rods, an example of which is shown in FIG. 2B, would see a noise reduction of up to 15 dB.

In the case of no reinforcing rods, the chemical composition and the mechanical resistance of the rubber material reinforced with transverse fibers, for the endless belt 12 devoid of reinforcing rods, may be selected to ensure rigidity of the endless belt 12. Such rubber material, with a transverse rigidity much larger than its longitudinal rigidity, allows fabricating a belt with a transverse rigidity high enough for allowing traction of the vehicle, while having a smaller longitudinal rigidity allowing the belt to be driven around the sprocket wheel, thereby reducing resistance to forward movements. A transverse rigidity superior by about 5 to 10 duros to that of rubber usually used in rod-reinforced belts (of a hardness of typically about 60 duros) may be a target.

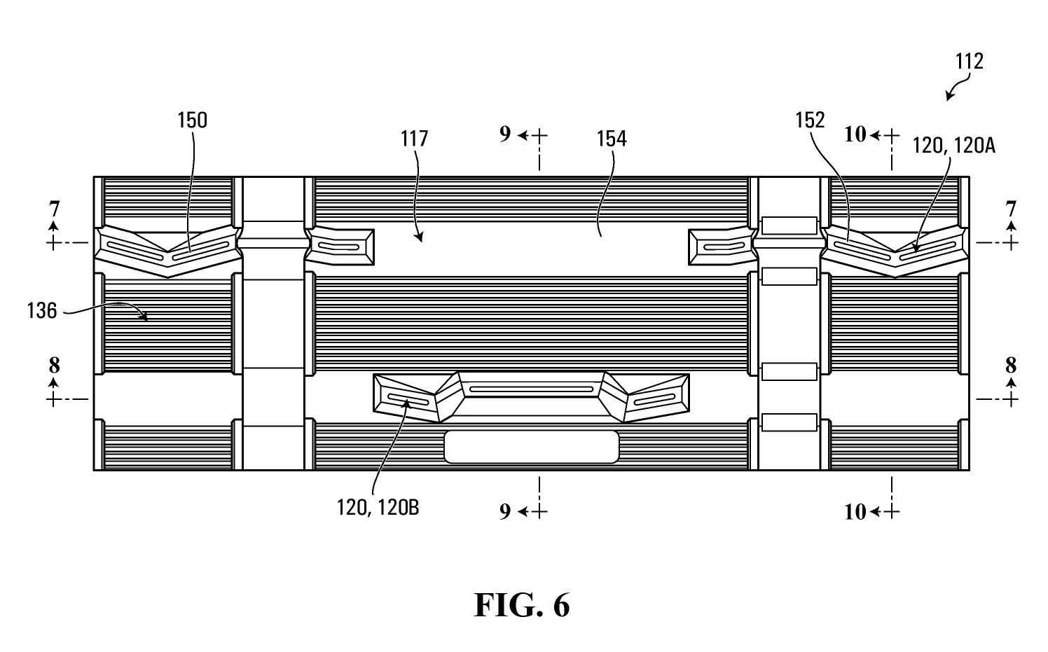

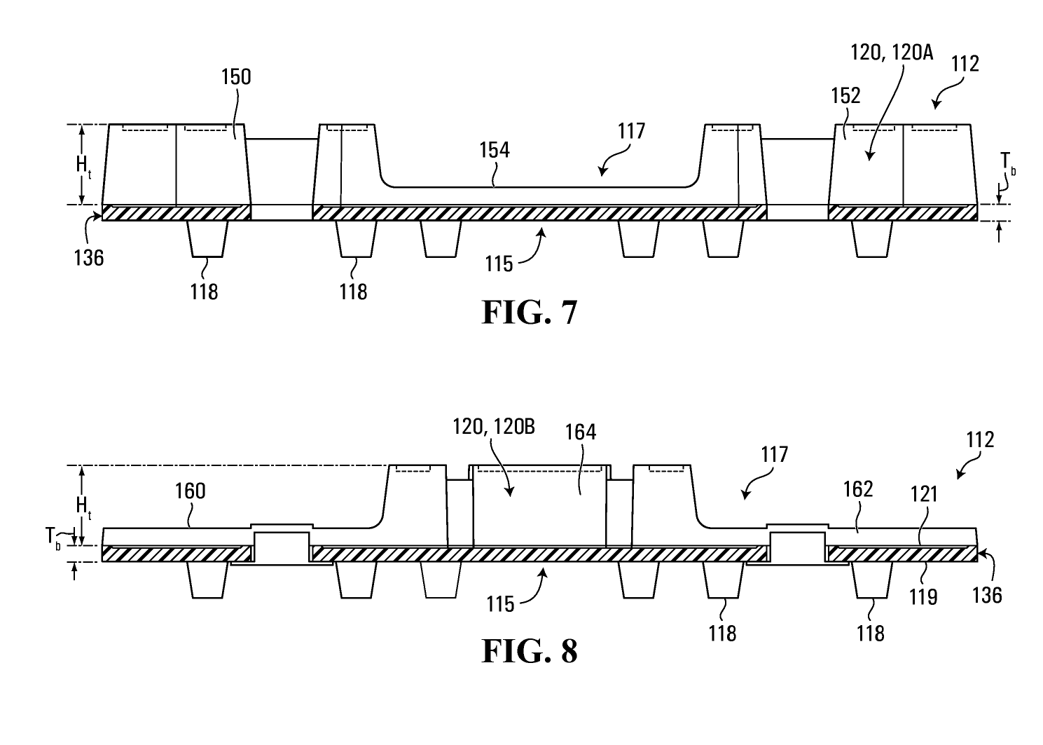

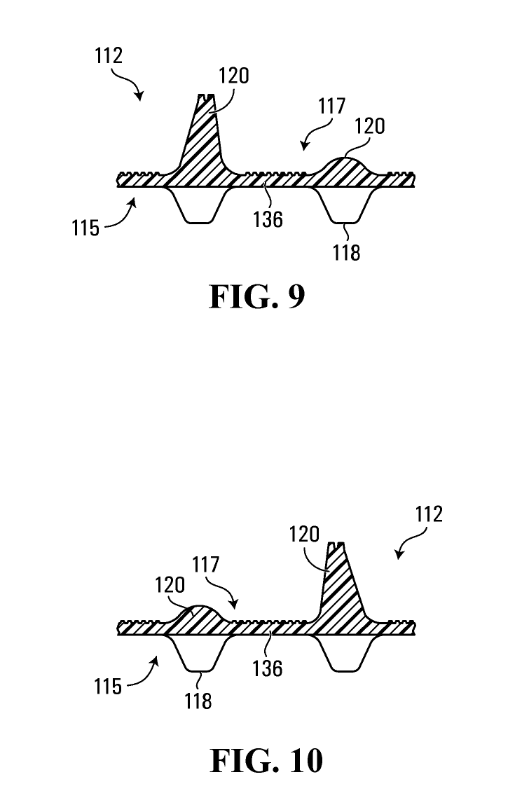

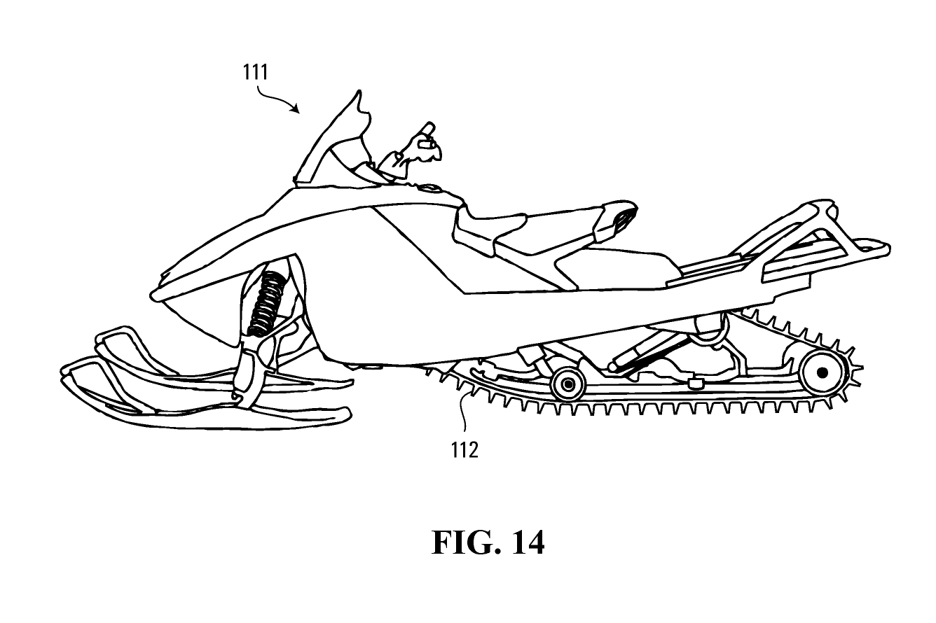

Another example of an embodiment of an endless track 112 free of transversal reinforcing rods will be described with reference to FIGS. 6 to 10. In this embodiment, the endless track 112 is configured for engaging the ground to provide traction to a snowmobile 111, an example of which is shown in FIG. 14.

The endless track 112 has an inner side 115 facing a plurality of wheels of the snowmobile 111, which includes a drive wheel (e.g., a drive sprocket) for imparting motion to the endless track 112. The track 112 also has a ground-engaging outer side 117 opposite the inner side 115 and engaging the ground on which the snowmobile 111 travels.

The endless track 112 comprises a body 136 underlying its inner side 115 and its ground-engaging outer side 117. In view of its underlying nature, the body 136 can be referred to as a “carcass”. The carcass 136 is an elastomeric body in that it comprises elastomeric material which allows the track 112 to elastically change in shape as it is in motion around the wheels. The elastomeric material of the carcass 136 can be any polymeric material with suitable elasticity. In this embodiment, the elastomeric material includes rubber. Various rubber compounds may be used and, in some cases, different rubber compounds may be present in different areas of the carcass 136. In other embodiments, the elastomeric material of the carcass 136 may include another elastomer in addition to or instead of rubber (e.g., polyurethane elastomer).

The carcass 136 may also comprise a plurality of reinforcements embedded in its elastomeric material. An example of a reinforcement is a layer of reinforcing cables that are adjacent to one another and that extend in the longitudinal direction of the track 112 to enhance strength in tension of the track 112 along its longitudinal direction. A reinforcing cable may be a cord or wire rope including a plurality of strands or wires, or may be another type of cable and may be made of any material suitably flexible longitudinally (e.g., fibers or wires of metal, plastic or composite material). Another example of a reinforcement is a layer of reinforcing fabric. Reinforcing fabric comprises pliable material made usually by weaving, felting, or knitting natural or synthetic fibers. For instance, a layer of reinforcing fabric may comprise a ply of reinforcing woven fibers (e.g., nylon fibers or other synthetic fibers).

The carcass 136 has a thickness T_{b} which is relatively small. The thickness T_{b} of the carcass 36 is measured from an inner surface 119 to a ground-engaging outer surface 121 of the carcass 36. For example, in some embodiments, the thickness T_{b} of the carcass 136 may be no more than 0.250 inches, in some cases no more than 0.240 inches, in some cases no more than 0.230 inches, in some cases no more than 0.220 inches, in some cases no more than 0.210 inches, in some cases no more than 0.200 inches, and in some cases even less (e.g., 0.180 or 0.170 inches).

In this embodiment, the inner side 115 of the endless track 112 comprises a plurality of inner projections 118 that contact at least some of the wheels of the snowmobile 111 and that are used to do at least one of driving (i.e., imparting motion to) the track 112 and guiding the track 112. In that sense, each inner projection 118 can be referred to as a “drive/guide projection” in that it is used to do at least one of driving the track 112 and guiding the track 112. More particularly, in this embodiment, at least some of the drive/guide projections 118 interact with the drive wheel of the snowmobile 111 in order to cause the track 112 to be driven. The drive/guide projections 118 are spaced apart along the longitudinal direction of the endless track 112. In this case, the drive/guide projections 118 are arranged in a plurality of rows that are spaced apart in the transversal direction of the endless track 112.

Each drive/guide projection 118 is an elastomeric drive/guide projection in that it comprises elastomeric material. The elastomeric material of the drive/guide projection 118 can be any polymeric material with suitable elasticity. More particularly, in this case, the elastomeric material of the drive/guide projection 118 includes rubber. Various rubber compounds may be used and, in some cases, different rubber compounds may be present in different areas of the drive/guide projection 118. In other cases, the elastomeric material of the drive/guide projection 118 may include another elastomer in addition to or instead of rubber.

The ground-engaging outer side 117 of the endless track 112 comprises a plurality of traction projections 120 that engage snow and/or other ground matter to enhance traction. The traction projections 120 are spaced apart in the longitudinal direction of endless track 112.

Each traction projection 120 is an elastomeric traction projection 120 in that it comprises elastomeric material. The elastomeric material of the traction projection 120 can be any polymeric material with suitable elasticity. More particularly, in this case, the elastomeric material of the traction projection 120 includes rubber. Various rubber compounds may be used and, in some cases, different rubber compounds may be present in different areas of the traction projection 120. In other cases, the elastomeric material of the traction projection 120 may include another elastomer in addition to or instead of rubber.

The traction projections 120 may be shaped in various ways. For example, in this embodiment, each traction projection 120 comprises a plurality of portions having different shapes. More particularly, in this example, the traction projection 120A comprises a first lateral portion 150 which is relatively high and non-straight (in this case, defining certain angles), a second lateral portion 152 which is relatively high and non-straight (in this case, defining certain angles), and a central portion 154 between the lateral portions 150, 152 which is relatively short and straight. The traction projection 120B comprises a first lateral portion 160 which is relatively short and straight, a second lateral portion 162 which is relatively short and straight, and a central portion 164 which is relatively high and non-straight (in this case, defining certain angles). The traction projections 120 may be shaped in any other suitable manner in other embodiments.

Each traction projection 120 has a height Hₜ, which is measured from the outer surface 121 of the carcass 136 in the thickness direction of the endless track 112. The height Hₜ of the traction projection 120 is substantially greater than the thickness T_{b} of the carcass 36. For example, in some embodiments, a ratio Hₜ/T_{b} of the height Hₜ of the traction projection 120 to the thickness T_{b} of the carcass 36 may be at least 2, in some cases at least 2.5, in some cases at least 3, in some cases at least 3.5, and in some cases even more (e.g., at least 4 or at least 5). For instance, in some embodiments, the height Hₜ of the traction projection 120 may be at least 0.70 inches, in some cases at least 0.80 inches, in some cases at least 0.90 inches, in some cases at least 1 inch, in some cases at least 1.10 inches, in some cases at least 1.20 inches, in some cases at least 1.30 inches, and in some cases even more (e.g., at least 2 inches or at least 3 inches).

As mentioned above, the endless track 112 is free of transversal reinforcing rods (i.e., reinforcing rods extending transversally to its longitudinal direction). With this absence of transversal reinforcing rods, when the snowmobile 111 is operated, less noise is generated than if the endless track 112 had transversal reinforcing rods embedded in its carcass 136 where respective ones of the traction projections 120 are located but was otherwise identical.

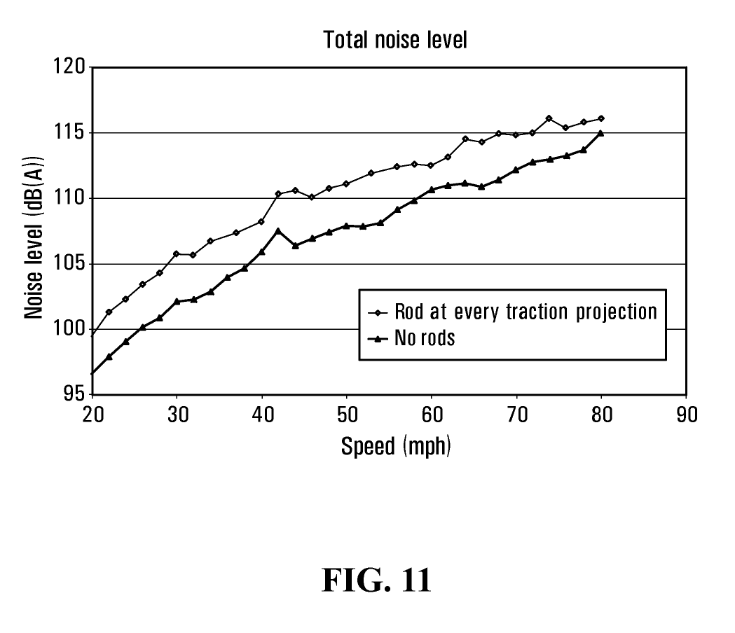

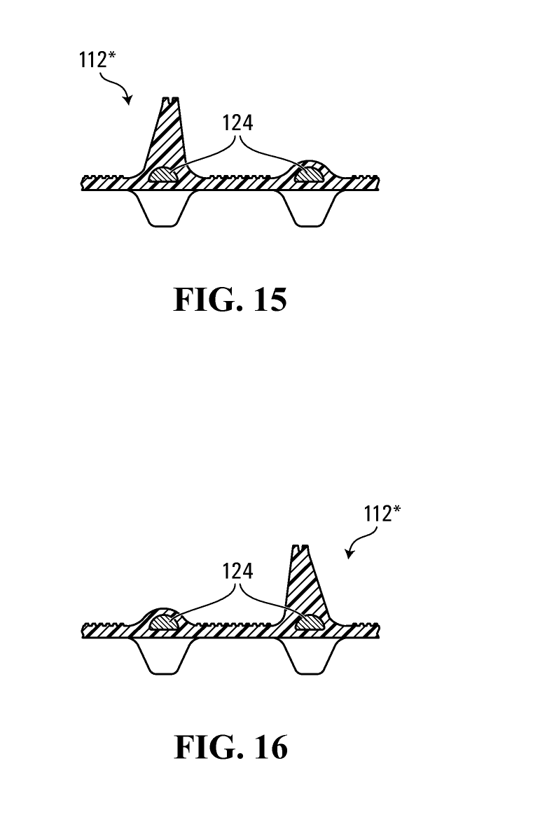

For instance, FIGS. 11 to 13 show results of sound tests conducted on the endless track 112 and a comparative reference endless track 112* which is identical to the endless track 112 except that it comprises transversal reinforcing rods 124 embedded in its carcass where respective ones of its traction projections are located, as shown in FIGS. 15 and 16.

When the snowmobile is operated in a range of speeds, which in this case reaches 80 mph, a total noise level generated if the snowmobile is equipped with the endless track 112 is less than that generated if the snowmobile is equipped with the reference endless track 112*. In this example, the difference in total noise level at a given speed is over 2 dB for most of the range of speeds. In particular, the difference in total noise level at a given speed is at least 3 dB for most of the range of speeds between 40 mph and 60 mph. At some speeds, the difference in total noise level is over 3.5 dB (e.g., at 54 mph) or over 4 dB (e.g., at 44 mph).

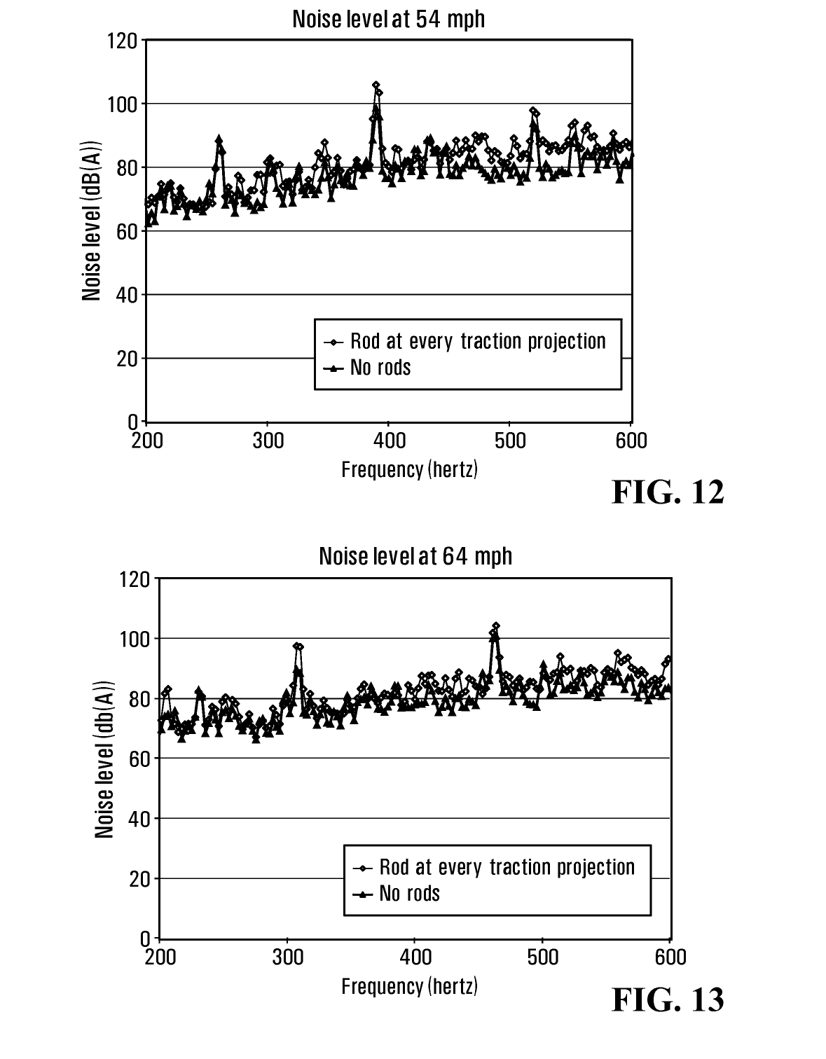

A sound spectrum of noise generated when the snowmobile is operated at a given speed manifests noise levels at respective frequencies that are less if the snowmobile is equipped with the endless track 112 than if the snowmobile is equipped with the reference endless track 112*. In particular, a highest noise level of the sound spectrum may be less if the snowmobile is equipped with the endless track 112 than if the snowmobile is equipped with the reference endless track 112*. FIG. 12 shows an example of a sound spectrum at a speed of 54 mph. Various noise levels at respective frequencies are smaller with the endless track 112 than with the reference endless track 112*. For instance, at frequencies of 340 Hz and 520 Hz, the noise level if the snowmobile is equipped with the endless track 112 is respectively 11.5 dB and 4 dB less than if the snowmobile is equipped with the reference endless track 112*. Also, a highest noise level of the sound spectrum, in this case at a frequency of 390 Hz, is more than 7 dB less if the snowmobile is equipped with the endless track 112 than if the snowmobile is equipped with the reference endless track 112*. FIG. 13 shows another example of a sound spectrum at a speed of 64 mph. Again, various noise levels at respective frequencies are smaller with the endless track 112 than with the reference endless track 112*. For instance, at a frequency of 310 Hz, the noise level if the snowmobile is equipped with the endless track 112 is 8.5 dB less than if the snowmobile is equipped with the reference endless track 112*. Also, a highest noise level of the sound spectrum, in this case at a frequency of 465 Hz, is 3.5 dB less if the snowmobile is equipped with the endless track 112 than if the snowmobile is equipped with the reference endless track 112*.

The noise reduction achieved with the endless track 112 may be particularly significant in light of the thinness of the carcass 136 of the track 112. Indeed, the absence of transversal reinforcing rods in the track 112 may create a greater noise reduction effect than if the carcass 136 of the track 112 was thicker since there is less rubber that would “shield” reinforcing rods if such reinforcing rods were embedded in the carcass 136 of the track 112 (as in the reference endless track 112*).

While the above examples present a certain degree of noise reduction achieved with the endless track 112 in this embodiment, the noise reduction achieved with the endless track 112 may be different than that presented in the above examples in other embodiments.

Since it does not have transversal reinforcing rods, the endless track 112 is less rigid in its transversal direction than if it comprised transversal reinforcing rods embedded in its carcass 136. Nevertheless, in this embodiment, the endless track 112 has a transversal rigidity (i.e., rigidity in its transversal direction) which is substantially greater than a longitudinal rigidity (i.e., rigidity in its longitudinal direction) thereof. For example, in some embodiments, the transversal rigidity of the endless track 112 may be at least twice, in some cases at least three times, in some cases at least four times, and in some cases at least five times the longitudinal rigidity of the endless track 122, and in some cases even more.

The transversal rigidity of the endless track 112 may be imparted in various ways.

For example, as mentioned above, in some embodiments, transverse fibers may be embedded in the rubber of the endless track 112. By extending generally in the transversal direction of the endless track 112, these fibers rigidify the endless track 112 in that direction.

As another example, in some embodiments, the elastomeric material of the endless track 112 may be selected to create a stiffer and/or harder track. More particularly, the elastomeric material of the endless track 112 may be more rigid than (i.e., have an average modulus of elasticity greater than that of) and/or be harder than (i.e., have an average hardness greater than that of) elastomeric material which would be used if the endless track 112 comprised transversal reinforcing rods.

For instance, in some embodiments, the elastomeric material of the endless track 112 may have an average modulus of elasticity no lower than a certain threshold. For instance, in some embodiments, the elastomeric material of the endless track 112 may have an average modulus of elasticity of at least 5.4 MPa, in some cases at least 5.6 MPa, in some cases at least 5.8 MPa, in some cases at least 6.0 MPa, and even more in some cases (e.g., 6.5 MPa or more). In embodiments in which the elastomeric material of the endless track 112 contains a single elastomer, the average modulus of elasticity of the elastomeric material of the endless track 112 is the modulus of elasticity of this single elastomer. In embodiments in which the elastomeric material of the endless track 112 contains two or more different elastomers, the average modulus of elasticity of the elastomeric material of the endless track 112 is taken as a weighted average modulus of elasticity, which is obtained by multiplying a proportion (%) of each elastomer in the elastomeric material of the endless track 112 by that elastomer's modulus of elasticity and then summing the results. That is, if the elastomeric material of the endless track 112 contains N elastomers, the average modulus of elasticity is

$${λ}_{avg} = {\sum }_{i = 1}^{N} {P}_{i} {λ}_{i}$$

where λᵢ is the modulus of elasticity of elastomer “i” and Pᵢ is the proportion (%) of elastomer “i” in the elastomeric material of the endless track 112. For instance, in an embodiment in which the elastomeric material of the endless track 112 contains two types of rubbers, say rubber “A” having a modulus of elasticity of 1.9 MPa and being present in a proportion of 15% and rubber “B” having a modulus of elasticity of 6.3 MPa and being present in a proportion of 85%, the average modulus of elasticity of the elastomeric material of the endless track 112 is 5.64 MPa. An elastomer's modulus of elasticity can be obtained from a standard ASTM D-412-A test (or equivalent test) based on a measurement at 100% elongation of the elastomer.

Alternatively or additionally, in some embodiments, the elastomeric material of the endless track 112 may have an average hardness no lower than a certain threshold. For instance, in some embodiments, the elastomeric material of the endless track 112 may have an average hardness of at least 80 durometers (Shore A), in some cases at least 82 durometers, in some cases at least 84 durometers, and even more in some cases (e.g., 88 or 90 durometers or more). In embodiments in which the elastomeric material of the endless track 112 contains a single elastomer, the average hardness of the elastomeric material of the endless track 112 is the hardness of this single elastomer. In embodiments in which the elastomeric material of the endless track 112 contains two or more different elastomers, the average hardness of the elastomeric material of the endless track 112 is taken as a weighted average hardness, which is obtained by multiplying a proportion of each elastomer in the elastomeric material of the endless track 112 by that elastomer's hardness and then summing the results. That is, if the elastomeric material of the endless track 112 contains N elastomers, the average hardness is

$${A}_{avg} = {\sum }_{i = 1}^{N} {P}_{i} {A}_{i}$$

where Aᵢ is the hardness of elastomer “i” and Pᵢ is the proportion (%) of elastomer “i” in the elastomeric material of the endless track 112. In cases where this calculated value is not an integer and the hardness scale is only in integers, this calculated value rounded to the nearest integer gives the average hardness. An elastomer's hardness can be obtained from a standard ASTM D-2240 test (or equivalent test).

As yet another example, in some embodiments, the elastomeric material of the endless track 112 may contain two or more different elastomers which have different rigidities and a proportion (%) of a stiffer (i.e., most rigid) one of these elastomers may be no lower than a certain threshold. For example, in some embodiments, the proportion of the stiffer one of the different elastomers of the endless track 112 may be at least 80%, in some cases at least 85%, in some cases at least 90%, and even more in some cases (e.g., 95% or more). The different elastomers may be provided as distinct layers (e.g., sheets) during molding of the endless track 112. An example of such a track is that presented above with two different types of rubbers, namely rubber “A” having a modulus of elasticity of 1.9 MPa and being present in a proportion of 15% and rubber “B” having a modulus of elasticity of 6.3 MPa and being present in a proportion of 85%.

As yet another example, in some embodiments, the traction projections 120 may rigidify the endless track 112 transversely. For instance, in this embodiment, by having its height substantially greater than the thickness of the carcass 136, each traction projection 120 provides a substantive mass which stiffens the track 112 transversely. Indeed, by being relatively massive, the traction projection 120 creates a resistance to transversal flexing of the track 112 where it is located. Collectively, the resistance to transversal flexing of the track 112 offered by multiple ones of the traction projections 120 thus help to rigidify the track 112 in its transversal direction.

Also, in some embodiments, the elastomeric material of the traction projections 120 may be more rigid than the elastomeric material of the carcass 136. For example, in some embodiments, an average modulus of elasticity of the elastomeric material of a traction projection 120 may be greater than an average modulus of elasticity of the elastomeric material of the carcass 136. For instance, in some embodiments, a ratio of the average modulus of elasticity of the elastomeric material of the traction projection 120 to the average modulus of elasticity of the elastomeric material of the carcass 136 may be at least 1.5, in some cases at least 2, in some cases at least 2.5, in some cases at least 3, and even more in some cases. The average modulus of elasticity of the elastomeric material of the traction projection 120 and the average modulus of elasticity of the elastomeric material of the carcass 136 can be obtained as discussed above.

Alternatively or additionally, in some embodiments, the elastomeric material of the traction projections 120 may be harder than the elastomeric material of the carcass 136. For instance, in some embodiments, a ratio of an average hardness of the elastomeric material of a traction projection 120 to an average hardness of the carcass 136 may be at least 1.5 and even more in some cases. The average hardness of the elastomeric material of the traction projection 120 and the average hardness of the elastomeric material of the carcass 136 can be obtained as discussed above.

Such tracks are of particular interest for snowmobiles intended for use in protected environments, such as national parks for example, which have stringent regulations such as speed limits around 40 ml/hr and low noise impact.

Although various embodiments and examples have been presented, this was for the purpose of describing, but not limiting, the invention. Various modifications and enhancements will become apparent to those of ordinary skill in the art and are within the scope of the invention, which is defined by the appended claims.

1. An endless track for providing traction to a snowmobile, the endless track comprising:
an elastomeric body comprising an inner side for facing a plurality of wheels of the snowmobile and a ground-engaging outer side for engaging the ground, the plurality of wheels comprising a drive wheel to impart motion to the endless track, the elastomeric body having a thickness; and
a plurality of elastomeric traction projections on the ground-engaging outer side, each elastomeric traction projection of the plurality of elastomeric traction projections having a height greater than the thickness of the elastomeric body;
the endless track being free of transversal reinforcing rods extending transversally to a longitudinal direction of the endless track.

2. The endless track claimed in claim 1, wherein the height of the elastomeric traction projection is at least twice the thickness of the elastomeric body.

3. The endless track claimed in claim 1, wherein the height of the elastomeric traction projection is at least three times the thickness of the elastomeric body.

4. The endless track claimed in claim 1, wherein the height of the elastomeric traction projection is at least four times the thickness of the elastomeric body.

5. The endless track claimed in claim 1, wherein the thickness of the elastomeric body is no more than 0.250 inches.

6. The endless track claimed in claim 1, wherein the thickness of the elastomeric body is no more than 0.230 inches.

7. The endless track claimed in claim 1, wherein the thickness of the elastomeric body is no more than 0.210 inches.

8. The endless track claimed in claim 1, wherein the height of the elastomeric traction projection is at least 0.70 inches.

9. The endless track claimed in claim 1, wherein the height of the elastomeric traction projection is at least 0.90 inches.

10. The endless track claimed in claim 1, wherein the height of the elastomeric traction projection is at least 1.10 inches.

11. The endless track claimed in claim 1, wherein, when the snowmobile is operated at a given speed, less noise is generated than if the endless track had transversal reinforcing rods embedded in the elastomeric body where respective ones of the elastomeric traction projections are located but was otherwise identical.

12. The endless track claimed in claim 11, wherein, when the snowmobile is operated at the given speed, a total noise level generated is over 2 dB less than if the endless track had transversal reinforcing rods embedded in the elastomeric body where respective ones of the elastomeric traction projections are located but was otherwise identical.

13. The endless track claimed in claim 11, wherein, when the snowmobile is operated at the given speed, a total noise level generated is at least 3 dB less than if the endless track had transversal reinforcing rods embedded in the elastomeric body where respective ones of the elastomeric traction projections are located but was otherwise identical.

14. The endless track claimed in claim 11, wherein, when the snowmobile is operated at the given speed, a total noise level generated is at least 4 dB less than if the endless track had transversal reinforcing rods embedded in the elastomeric body where respective ones of the elastomeric traction projections are located but was otherwise identical.

15. The endless track claimed in claim 11, wherein, when the snowmobile is operated at the given speed, a sound spectrum of noise generated manifests a highest noise level that is over 3 dB less than if the endless track had transversal reinforcing rods embedded in the elastomeric body where respective ones of the elastomeric traction projections are located but was otherwise identical.

16. The endless track claimed in claim 11, wherein, when the snowmobile is operated at the given speed, a sound spectrum of noise generated manifests a highest noise level that is over 7 dB less than if the endless track had transversal reinforcing rods embedded in the elastomeric body where respective ones of the elastomeric traction projections are located but was otherwise identical.

17. The endless track claimed in claim 11, wherein the given speed is between 40 miles per hour and 60 miles per hour.

18. The endless track claimed in claim 1, wherein elastomeric material of the endless track has an average modulus of elasticity of at least 5.4 MPa.

19. The endless track claimed in claim 1, wherein elastomeric material of the endless track has an average modulus of elasticity of at least 5.6 MPa.

20. The endless track claimed in claim 1, wherein elastomeric material of the endless track has an average modulus of elasticity of at least 5.8 MPa.

21. The endless track claimed in claim 1, wherein elastomeric material of the endless track has an average hardness of at least 80 durometers (Shore A).

22. The endless track claimed in claim 1, wherein elastomeric material of the endless track has an average hardness of at least 84 durometers (Shore A).

23. The endless track claimed in claim 1, wherein elastomeric material of the endless track has an average hardness of at least 88 durometers (Shore A).

24. The endless track claimed in claim 1, wherein elastomeric material of the endless track contains a plurality of different elastomers which have different rigidities, a proportion of a most rigid one of the different elastomers being at least 80%.

25. The endless track claimed in claim 1, wherein elastomeric material of the endless track contains a plurality of different elastomers which have different rigidities, a proportion of a most rigid one of the different elastomers being at least 85%.

26. The endless track claimed in claim 1, wherein elastomeric material of the endless track contains a plurality of different elastomers which have different rigidities, a proportion of a most rigid one of the different elastomers being at least 90%.

27. The endless track claimed in claim 1, wherein elastomeric material of the elastomeric traction projection is more rigid than elastomeric material of the elastomeric body.

28. The endless track claimed in claim 1, wherein the elastomeric traction projection comprises a first portion defining the height of the traction projection and a second portion shorter than the first portion.

29. The endless track claimed in claim 28, wherein the elastomeric traction projection comprises a third portion defining the height of the traction projection, the second portion being located between the first portion and the third portion.

30. The endless track claimed in claim 1, comprising a plurality of elastomeric inner projections on the inner side, the inner projections being located to contact at least one of the wheels.

31. The endless track claimed in claim 30, wherein the inner projections are drive projections for engaging the drive wheel.

32. A snowmobile comprising the endless track claimed in claim 1.

33. An endless track for providing traction to a snowmobile, the endless track comprising:
an elastomeric body comprising an inner side for facing a plurality of wheels of the snowmobile and a ground-engaging outer side for engaging the ground, the plurality of wheels comprising a drive wheel to impart motion to the endless track; and
a plurality of elastomeric traction projections on the ground-engaging outer side;
the endless track being free of transversal reinforcing rods extending transversally to a longitudinal direction of the endless track, wherein, when the snowmobile is operated at a given speed, less noise is generated than if the endless track had transversal reinforcing rods embedded in the elastomeric body where respective ones of the elastomeric traction projections are located but was otherwise identical.

34. The endless track claimed in claim 33, wherein, when the snowmobile is operated at the given speed, a total noise level generated is over 2 dB less than if the endless track had transversal reinforcing rods embedded in the elastomeric body where respective ones of the elastomeric traction projections are located but was otherwise identical.

35. The endless track claimed in claim 33, wherein, when the snowmobile is operated at the given speed, a total noise level generated is at least 3 dB less than if the endless track had transversal reinforcing rods embedded in the elastomeric body where respective ones of the elastomeric traction projections are located but was otherwise identical.

36. The endless track claimed in claim 33, wherein, when the snowmobile is operated at the given speed, a total noise level generated is at least 4 dB less than if the endless track had transversal reinforcing rods embedded in the elastomeric body where respective ones of the elastomeric traction projections are located but was otherwise identical.

37. The endless track claimed in claim 33, wherein, when the snowmobile is operated at the given speed, a sound spectrum of noise generated manifests a highest noise level that is over 3 dB less than if the endless track had transversal reinforcing rods embedded in the elastomeric body where respective ones of the elastomeric traction projections are located but was otherwise identical.

38. The endless track claimed in claim 33, wherein, when the snowmobile is operated at the given speed, a sound spectrum of noise generated manifests a highest noise level that is over 7 dB less than if the endless track had transversal reinforcing rods embedded in the elastomeric body where respective ones of the elastomeric traction projections are located but was otherwise identical.

39. The endless track claimed in claim 33, wherein the given speed is between 40 miles per hour and 60 miles per hour.

40. The endless track claimed in claim 33, wherein the elastomeric body has a thickness and each elastomeric traction projection of the plurality of elastomeric traction projections has a height which is at least twice the thickness of the elastomeric body.

41. The endless track claimed in claim 33, wherein the elastomeric body has a thickness and each elastomeric traction projection of the plurality of elastomeric traction projections has a height which is at least three times the thickness of the elastomeric body.

42. The endless track claimed in claim 33, wherein the elastomeric body has a thickness and each elastomeric traction projection of the plurality of elastomeric traction projections has a height which is at least four times the thickness of the elastomeric body.

43. A snowmobile comprising the endless track claimed in claim 33.

44. An endless track for providing traction to a snowmobile, the endless track comprising:
an elastomeric body comprising an inner side for facing a plurality of wheels of the snowmobile and a ground-engaging outer side for engaging the ground, the plurality of wheels comprising a drive wheel to impart motion to the endless track; and
a plurality of elastomeric traction projections on the ground-engaging outer side;
the endless track being free of transversal reinforcing rods extending transversally to a longitudinal direction of the endless track, the endless track containing a plurality of different elastomers which have different rigidities.
